(19) United States
(12) Patent Application Publication
(10) Pub. No.: US 2025/0282065 A1
(43) Pub. Date: Sep. 11, 2025

(54) End Effector

(71) Applicant: Block One Automation, LLC, Fort Collins, CO (US)

(72) Inventor: Jonathan O’Neil, Fort Collins, CO (US)

(73) Assignee: Block One Automation, LLC, Fort Collins, CO (US)

(21) Appl. No.: 18/600,020

(22) Filed: Mar. 8, 2024

(51) Int. Cl. B25J 15/06; B65G 47/91

(52) U.S. Cl. CPC B25J 15/0683; B65G 47/91

(57) ABSTRACT

Generally, an end effector adapted to engage and move an object from a first location to a second location. Specifically, an end effector including one or more of a gripper movable on an upright mast to engage an object side, a support plate extendable in relation to the upright mast to engage an object bottom, and compressor arm movable on the upright mast to engage an object top, the end effector can be moved to correspondingly move the object.

### I. FIELD OF THE INVENTION

Generally, an end effector adapted to engage and move an object from a first location to a second location. Specifically, an end effector including one or more of a gripper movable on an upright mast to engage an object side, a support plate extendable in relation to the upright mast to engage an object bottom, and compressor arm movable on the upright mast to engage an object top, the end effector can be moved to correspondingly move the object.

### II. BACKGROUND OF THE INVENTION

Products can be accumulated and packed into cases or carrier trays (also referred to as a “pack”). The packs can be stacked, and generally a plurality of packs are stacked onto pallets. The cases or carrier trays in which products are accumulated can be comparatively light and insubstantial compared to the weight of the products contained in the cases or carrier trays. In certain instances, the cases or carrier trays can be so flimsy that the conventional method of picking or other movement of products accumulated in the cases or carrier trays can be only by hand and not by machine.

As an illustrative example, canned products can be accumulated in carrier trays in which the height of the cans exceed the height of the carrier tray sidewalls. Therefore, the can height exceeds the height of the carrier tray sidewall and a portion of can sides and can tops remain uncovered and unprotected by the carrier tray. A specific example is beer or soda cans accumulated in a 24 can cardboard carrier tray measuring 10⅝ inches×15½ inches×2¾ inches deep. The cans accumulated in the carrier tray can have a can height of between about 3⅝ inches to 5 inches and extend upward outside of the carrier tray sidewall.

Palletized cases and carrier trays can pose substantial problems for, and can preclude machine handling. In the instance of carrier cases and trays, the bottom of the case or carrier tray can be difficult to engage with a lift without damaging the top of an underlying case or the unprotected can tops in an underlying carrier tray. Additionally, upon lifting of a carrier tray, unless the lifting force on the carrier tray supports the carrier tray bottom, the upper portion of the cans can shift to the extent that the carrier tray distorts which can result in the carrier tray disengaging from a machine or the cans falling away from the carrier tray.

Therefore, movement of cases and carrier trays containing accumulated product may still be moved by hand and not by machine, such as, a manual mechanical lift or by automaton or robot. Moving cases and carrier trays by hand can involve the corresponding inefficiencies in time and labor. Therefore, there would be a substantial advantage in provision of an end effector, a method of making an end effector, and a method of using an end effector adapted to or configured to move cases or carrier trays and in particular cases or carrier trays stacked onto pallets which would otherwise be moved by hand.

### III. SUMMARY OF THE INVENTION

Accordingly, a broad object of particular embodiments of the invention can be to provide an end effector, including one or more of: an upright mast, a gripper movably coupled to the mast, wherein the gripper has a configuration to engage a pack side, a support plate extendable in relation to the upright mast, wherein the support plate has a configuration to engage a pack bottom, and a compressor arm movably coupled to said mast, wherein the compressor arm has a configuration to engage a pack top, wherein the end effector can be operated to engage the gripper to the pack side and upwardly move along the mast to lift a portion of the pack from an underlying pack, engage the support plate with the pack bottom, and engage the compressor arm to the package top. The end effector can subsequently move from a first location to a second location, to correspondingly move a pack from the first location, which can be a first pallet, to the second location, which can be a second pallet.

Another broad object of particular embodiments of the invention can be to provide a method of making an end effector, including one or more of: providing an upright mast, movably coupling a gripper to the upright mast, wherein the gripper has a configuration to engage a pack side, coupling a support plate in extendable retractable relation to the mast, wherein the support plate has a configuration to engage a pack bottom, and moveably coupling a compressor arm to the mast, wherein the compressor arm has a configuration to engage a pack top, and configuring the end effector to couple to a movement machine, such as an automaton or robot, whereby the configuration of the end effector allows: the gripper to engage the pack side and upwardly move along the mast to lift a portion of the pack from a surface or an underlying pack, the support plate to extend in relation to the mast to engage the pack bottom, and the compressor arm downwardly move to the engage a pack top. The end effector coupled to the movement machine, automaton, or robot can move the pack from a first location to a second location.

Another broad object of particular embodiments can be to provide a method of using an end effector including one or more of: moving an end effector proximate a package and operating the end effector to perform one or more of: engage a gripper with a package side, move the gripper upward on a mast to lift a portion of a pack bottom, extend a support plate in relation to the mast to engage the pack bottom lifted by the gripper, and lower a compressor arm to engage a pack top, and operating a machine, automaton or robot to move the end effector to correspondingly move the pack from a first location to a second location.

Naturally, further objects of the invention are disclosed throughout other areas of the specification, drawings, photographs, and claims.

### IV. BRIEF DESCRIPTION OF THE DRAWINGS

FIG. 1 is a top front perspective view of a particular embodiment of the inventive end effector.

FIG. 2 is a rear bottom perspective view of a particular embodiment of the inventive end effector.

FIG. 3 is a front elevation view of a particular embodiment of the inventive end effector.

FIG. 4 is rear elevation view of a particular embodiment of the inventive end effector.

FIG. 5 is a first side elevation view of a particular embodiment of the inventive end effector.

FIG. 6 is a second side elevation view of a particular embodiment of the inventive end effector.

FIG. 7 is a top plan view of a particular embodiment of the inventive end effector.

FIG. 8 is a bottom plan view of a particular embodiment of the inventive end effector.

FIG. 9 illustrates operating a particular embodiment of the inventive end effector to engage a gripper to a pack side.

FIG. 10 illustrates operating a particular embodiment of the inventive end effector to move the gripper upward on a mast to lift a portion of a pack bottom.

FIG. 11 illustrates operating a particular embodiment of the inventive end effector to extend a support plate in relation to said mast to support said package bottom lifted by said gripper.

FIG. 12 illustrates operating a particular embodiment of the inventive end effector to lower said compressor arm to engage a pack top.

FIG. 13 illustrates operating a particular embodiment of the inventive end effector to move a pack from a first location to a second location.

FIG. 14 is a block flow diagram of a method of using a particular embodiment of the inventive end effector to move a pack from a first location to a second location.

### V. DETAILED DESCRIPTION OF THE INVENTION

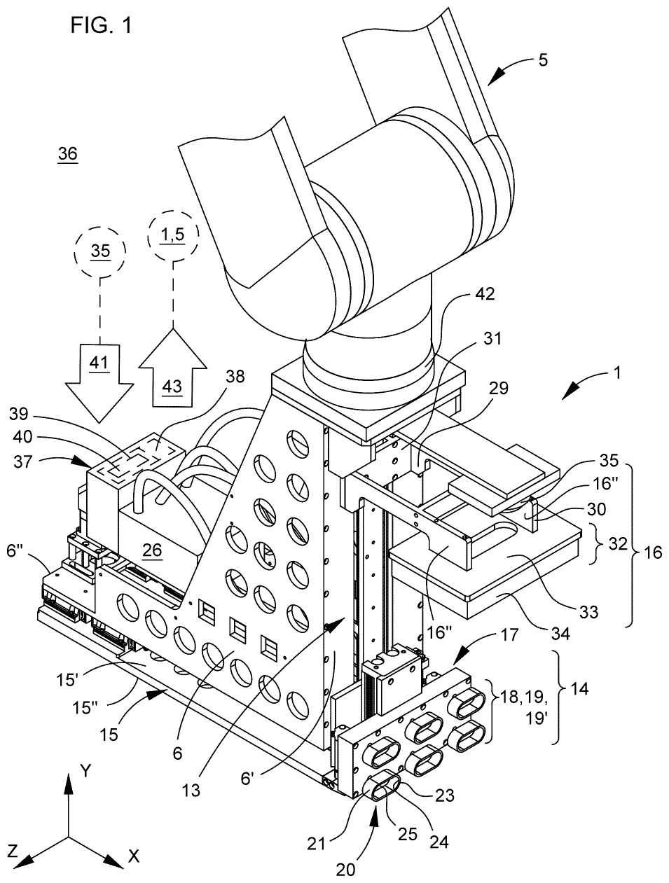

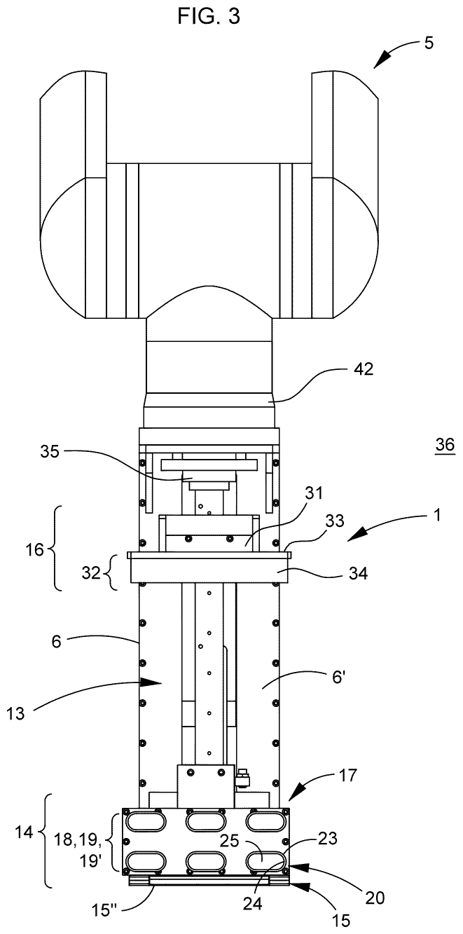

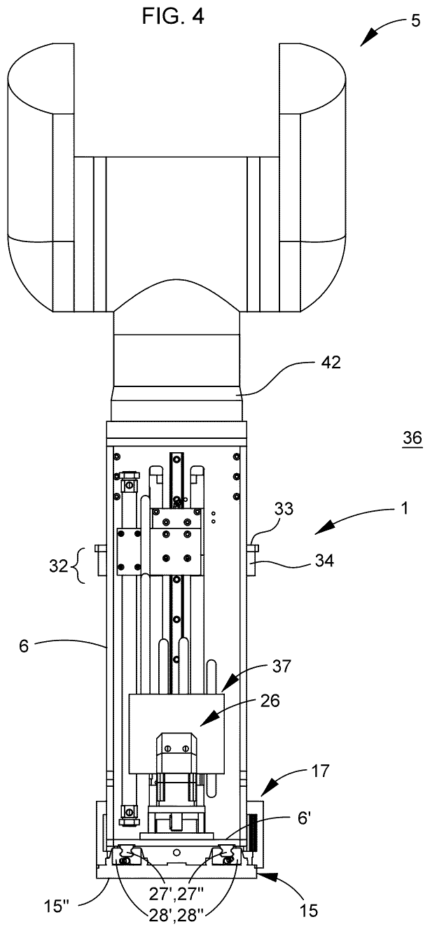

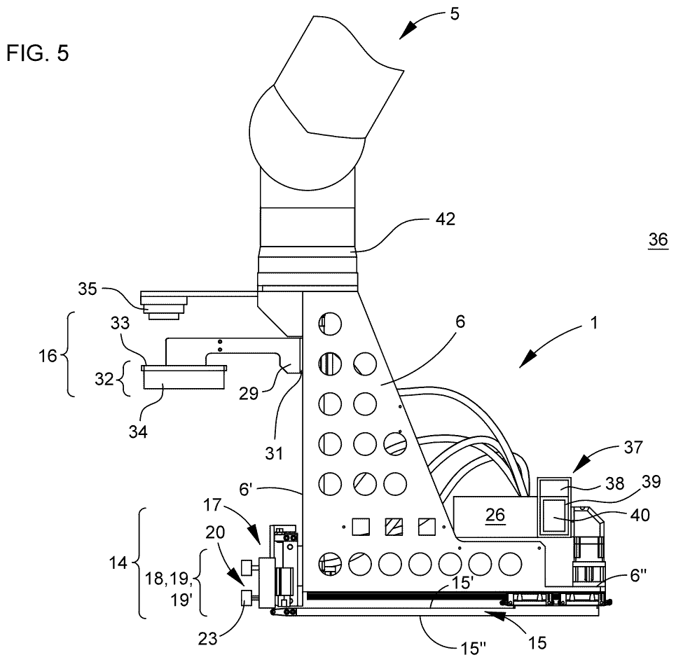

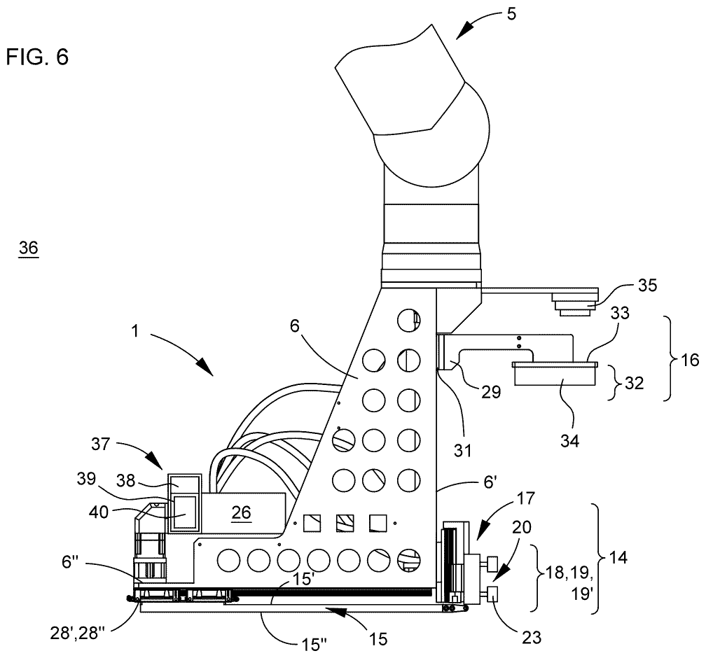

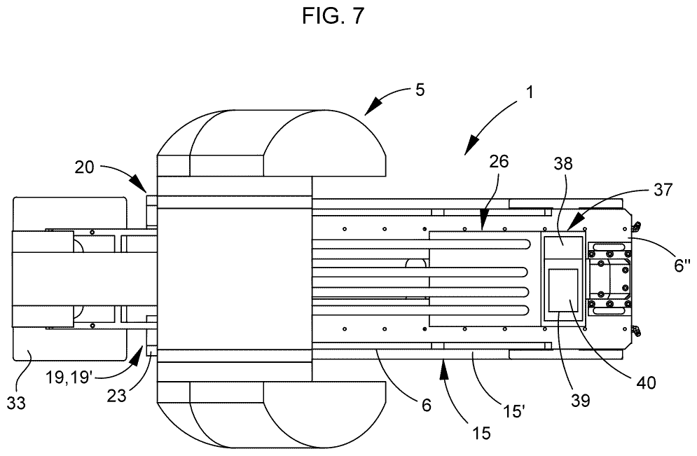

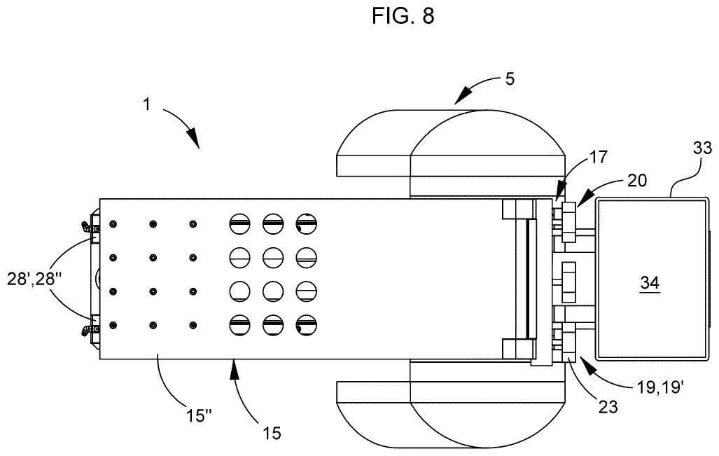

Generally, referring to FIGS. 1 through 13, which depict a particular embodiment of an inventive end effector (1), a method of making the end effector (1) and a method of using an end effector (1) to engage and move an object (2) from a first location (3) to a second location (4).

An end effector (1) comprises a peripheral device that can be attached to a movement mechanism (5), such as an automaton or a robot, that performs a task. The inventive end effector (1) can comprise an electromechanical device configured to engage an object (2) and move the object (2). The end effector (1) can include a framework (6) that operatively supports components of the end effector (1) in a configuration to engage an object (2) for movement by the movement mechanism (5). The illustrative example of an object (2) depicted in the Figures comprises a case or a carrier tray containing an accumulation of products (referred to as “a pack” (7)) stacked on a pallet (8); however, the term object (2) is not intended to be limited solely to cases or carrier trays, and a pack (7) can be any item having a pack top (9), a pack bottom (10) and a pack side (11). The recitation of move an object (2) from a first location (3) to a second location (4) should be broadly construed as any movement of the object (2) which separates a first object (2′) a distance from another object (2″), and specifically includes movement of the end effector (1) to separate a first pack (7′) a distance from a second pack (7″), or a first pack (7′) from stack of packs (7′″). As examples, the end effector (1) can move a first pack (7′) from a stack of packs (7′″) on a first pallet (8′) to stack of packs (7′″) on a second pallet (8″), or to a conveyor for sorting, or to a stationary surface.

Now, with primary reference to FIGS. 1 through 8, a particular embodiment of the inventive end effector (1) can include a framework (6) including an upright mast (13) which supports operation of one or more of: a gripper (14) movably coupled to the upright mast (13), a support plate (15) extendable in relation to the upright mast (13), and a compressor arm (16) movably coupled to the upright mast (13). The upright mast (13) can be adapted or configured to guide the upward and downward motion of the gripper (14) and the compressor arm (16) along the upright mast (13). The support plate (15) can be slidably coupled to the to the framework (6) and can be retractably extended below the gripper (14), and the examples, in substantially orthogonal relation to the upright mast (13).

Again, with primary reference to FIGS. 1 through 8, embodiments of the gripper (14) can include a gripper body (17) configured to movably couple to the upright mast (13) for upward and downward movement of the gripper (14) along the mast (13) and to provide a gripping surface (18) configured to grip an object (2) or pack (7). In particular embodiments, the gripping surface (18) can be a substantially flat rigid gripping surface (18). The gripping surface (18) may further include a conformable gripping layer (19) to engage objects (2) or packs (7) regardless of geometry. For example, the conformable gripping layer (19) can comprise an elastomer or foam layer (19′). The embodiment of the gripper surface (18) depicted in the Figures further includes one or more gripper cups (20). The one or more gripper cups (20) can be configured to engage the object (2) or a pack side (11) of a pack (7). In the embodiment depicted in the Figures, the one or more gripper cups (20) comprise a gripper cup annular side wall (21) extending from a gripper cup bottom (22). The gripper cup annular sidewall (21) can have a thickness disposed between a gripper cup annular sidewall external surface (23) and a gripper cup annular sidewall internal surface (24) defining a cup interior space (25). The one or more gripper cups (20) can be elastic both in radial and in axial direction and therefore offer conformable engagement with the object (2) or pack side (11) of a pack (7). In particular embodiments, the gripper cup (20) can enclose the cup interior space (25) adapted to or configured to fluidically couple to a vacuum source (26). The vacuum source (26) can be operated to draw a vacuum at the gripping surface (18), and in the particular embodiment shown in the Figures, within cup interior space (25) of the one or more gripper cups (20). While the gripper cups (20) depicted in the Figures have an oval or stadium configuration which can be fluidically coupled to the vacuum source (26); this illustrative example is not intended to preclude other configurations of the gripper cups (20) which may be circular, square, rectangular or other geometry capable of engaging an object (2) or pack (7) and moving the object (2) or pack (7) as the gripper (14) moves upward along the mast (13).

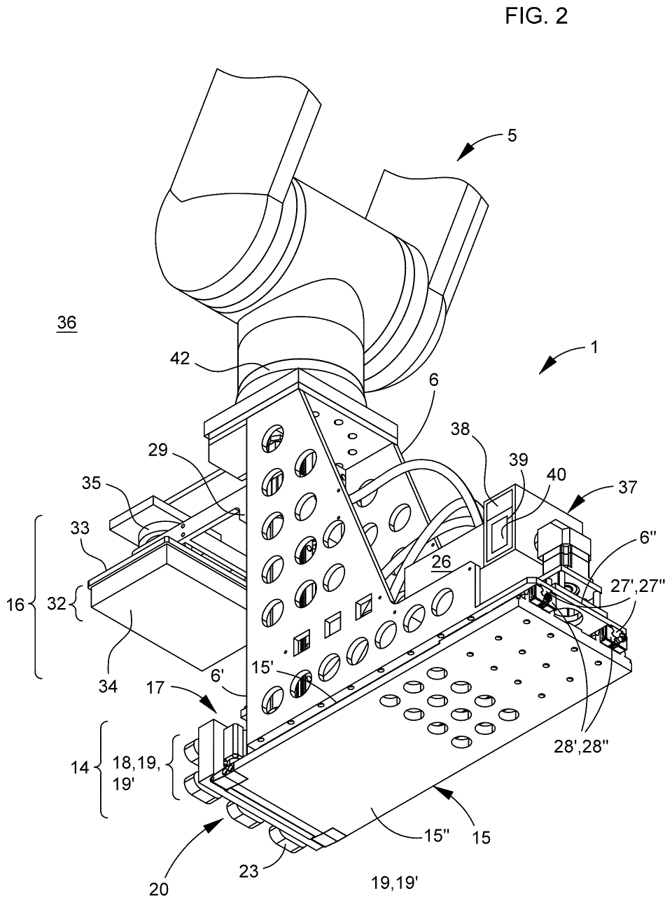

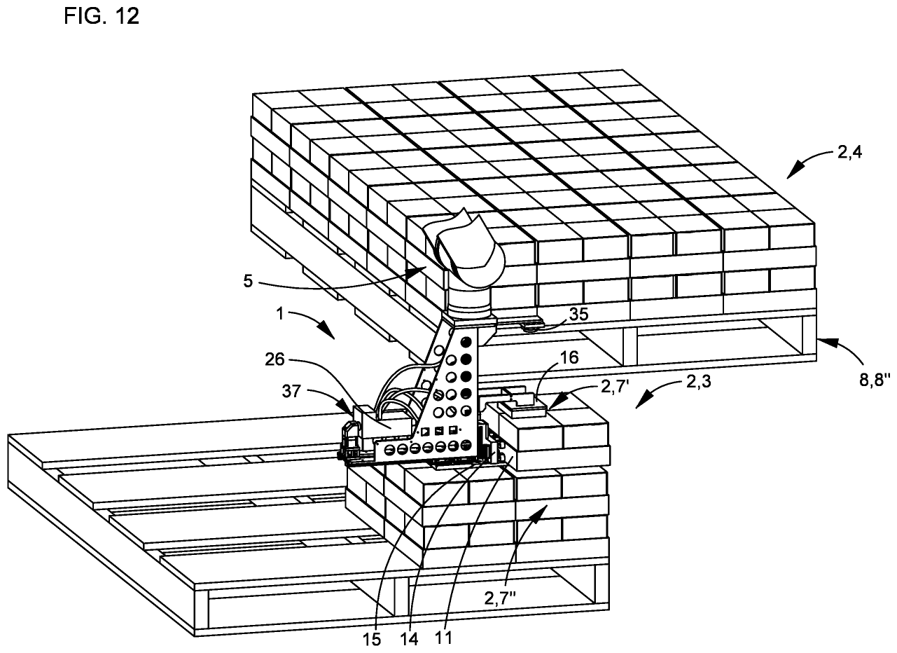

Again, with primary reference to FIGS. 1 through 8, embodiments of the support plate (15) extendable in relation to the upright mast (13) includes a plate first side (15′) opposite plate second side (15″). The plate first side (15′) and the plate second side (15′) can be configured to be disposed between a pair of packs (7′, 7″) stacked on a pallet (12) and engage a pack bottom (10) (as shown in the example of FIG. 12). A suitable configuration of the support plate (15) can include a plate first side (15′) facing the framework (6) being substantially flat over the portion extendable outward of the mast (13) and the plate second side (15″) facing away from the framework (6) being substantially flat; however, the plate first side (15′) and the plate second side (15″) can be configured to the particular geometry of the packs (7). The plate first side (15′) can be slidably mounted to the framework (6), and in the embodiment depicted, includes a pair of tracks (27′, 27″) disposed in parallel relation extending along the bottom of the framework (6) between the framework front end (6′) to the framework back end (6″) (as shown in the example of FIG. 2). Track followers (28′, 28″) coupled to the plate first side (15′) are configured to correspondingly slidably secure to the pair of tracks (27′, 27″). The track followers (28′, 28″) can slide in reciprocal direction along the pair of tracks (27′, 27″) to correspondingly extend and retract the support plate (15) in relation to the mast (13). In particular embodiments, the pair of tracks (27′, 27″) and corresponding track followers (28′, 28″) can comprise liner bearing slide rails, a pair of rods and corresponding linear bearings, or T-tracks and corresponding T-slides.

Again, with primary reference to FIGS. 1 through 8, embodiments of the compressor arm (16) can include a compressor arm first end (29) configured to couple to the mast (13) for upward and downward movement of the compressor arm (16) along the mast (13) opposite a compressor arm second end (30) terminating sufficiently forward of the mast (13) to be disposed over the pack top (9) when the gripper (14) engages the pack side (11). The compressor arm second end (30) can be configured to engage the pack top (9). In the embodiment depicted, the compressor arm first end (29) comprises a mounting plate (31) adapted to or configured to slidingly engage the mast (13) with a pair of compressor arms (16′, 16″) extending outward from the mast (13) terminating in the compressor arm second end (30) including a compression pad (32). The compression pad (32) upon engaging the pack top (9) can compress to conform to the geometry of the pack top (9). In particular embodiments, the compression pad (32) can comprise a rigid base (33) secured to the compressor arm second end (30) and a layer of compressible elastomer or compressible foam (34) secured to the rigid base (33). The term “compressible” means capable of or adapted to be forced into less space. The compression pad (32) can, but need not necessarily, be fluidically coupled to the vacuum source (26). As an illustrative example, a vacuum foam pad suitable for particular embodiments may be similar or equivalent to Vacuforce LLC, TXM130x400-A5-V.

Again, with primary reference to FIGS. 1 through 8, the movement mechanism or robot (5) and the end effector (1) can include one or more navigation sensors (35) to sense the position of the movement mechanism or robot (5) and the end effector (1) in the environment (36), and in particular, the spatial orientation of one or more of: the end effector (1) to a pack (7) to allow orientation of the gripper (14) in relation to the pack side (11), the orientation of the support plate (15) relative to the mast (13) and relative to the pack bottom (10), and the orientation of the compressor arm (16) in relation to the pack top (9). The navigation sensors (35) can include one or more of: an image sensor (camera), an infrared sensor (infrared camera), an accelerometer, capacitive or capacitive displacement sensors, inductive sensors, magnetic, photoelectric sensors, reflectivity sensors, laser-range finder sensors, infrared sensors, charge coupled sensors, radar sensors, ultrasonic sensors, fiber optics sensor, hall effect sensors, touch switch, or combinations thereof. As an illustrative example, a navigation sensor (35) can be located above the compressor arm (16) to sense the position of the end effector (1) to the pack top (9) or the position of the compressor arm (16) relative to the pack top (9).

Again, with primary reference to FIGS. 1 through 8, the inventive end effector (1) can be under control of a controller (37) including a processor (38) communicatively coupled to a non-transitory computer readable media (39) containing a program code (40). The controller (37) can be external and communicatively coupled to the movement mechanism or robot (5) or end effector (1) or can be internal to the movement mechanism or robot (5) or the end effector (1), or be distributed as both external and internal components communicatively coupled to the movement mechanism or robot (5) or the end effector (1). The controller (37) can receive and process input navigation sensor signals (41) from the one or more navigation sensors (35) and generate output control signals (43) that enable the movement mechanism or robot (5) and the end effector (1) to operate within the environment (36) to perform a task, and in particular, the methods of using the end effector (1) to move a pack (7).

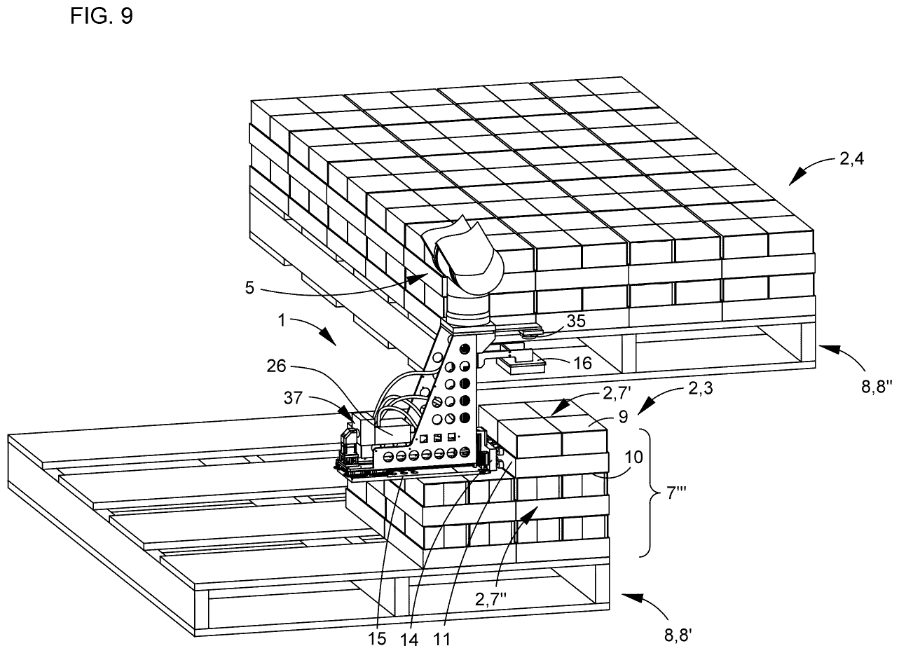

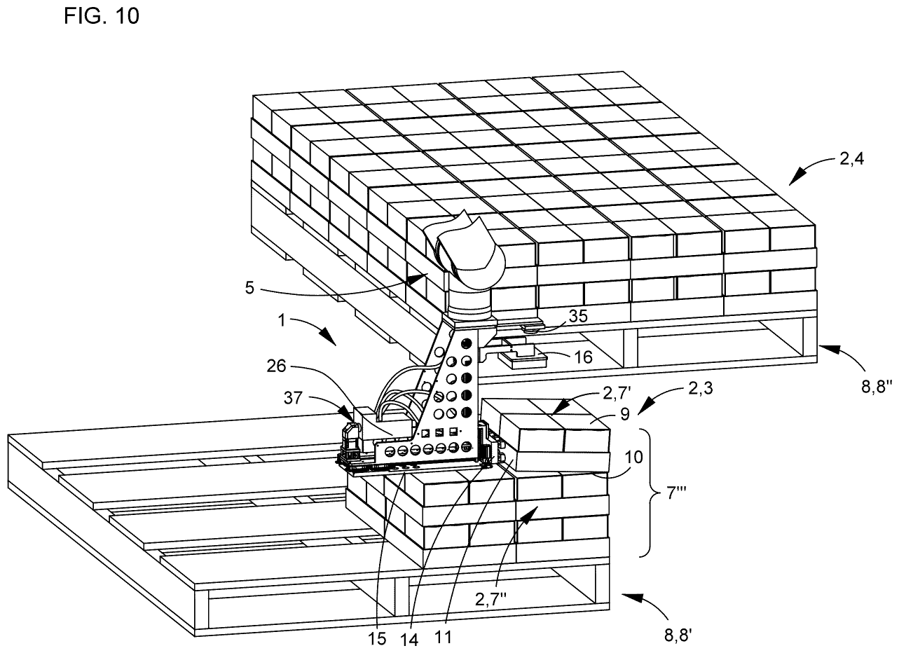

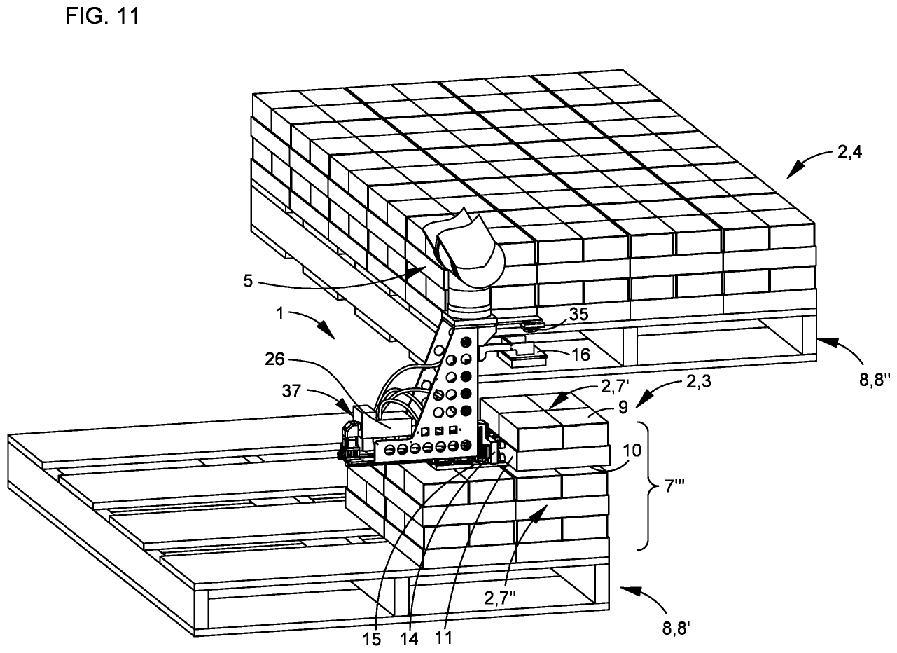

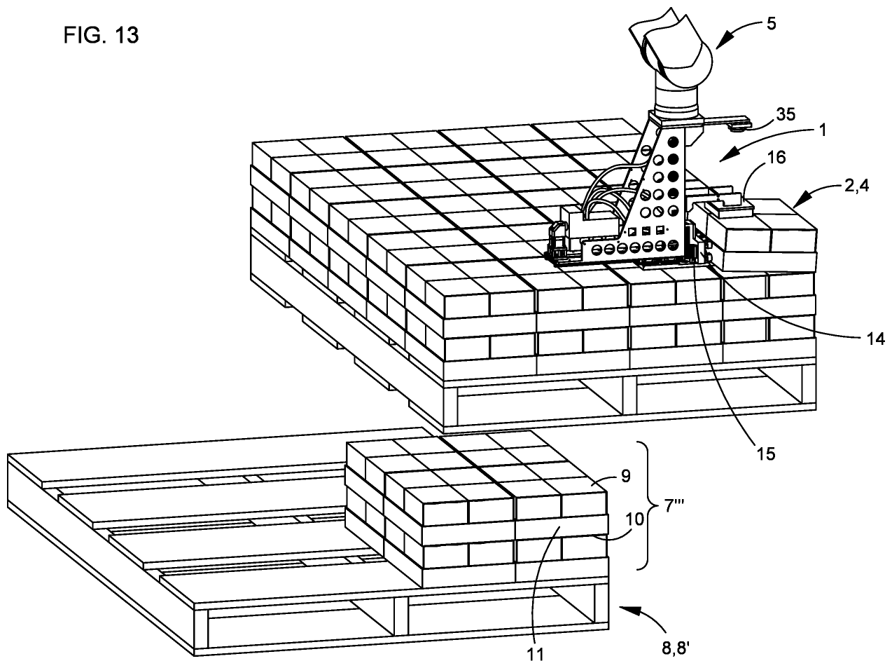

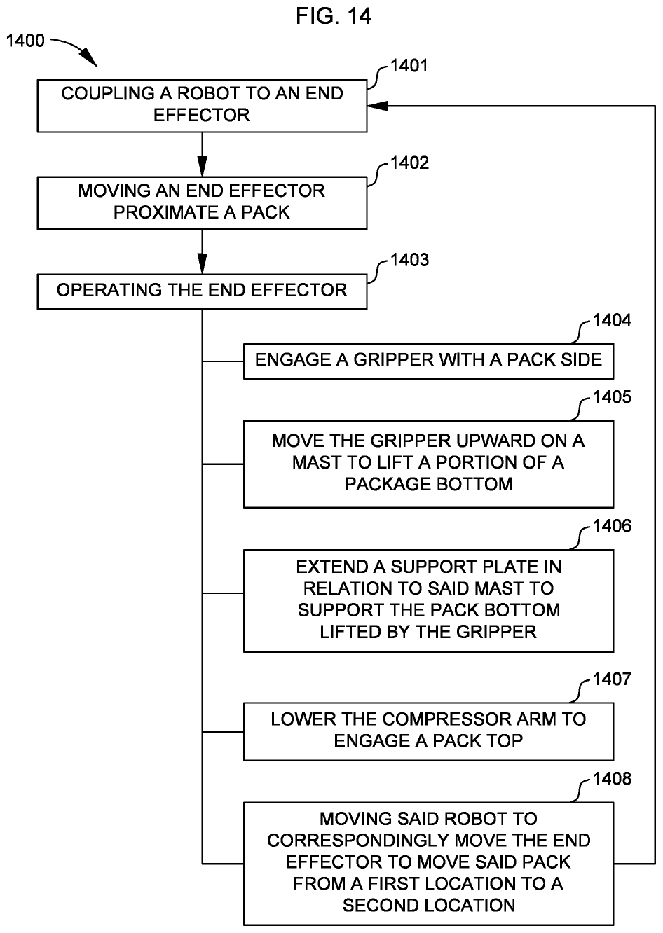

Now, with primary reference to FIGS. 9 through 14, an illustrative method of using particular embodiments of the inventive end effector (1) is shown (Block Flow 1400). The method can include one more of the following, although the stepwise order may differ depending on the particular application. The method can include coupling the movement mechanism or robot (5) to the end effector (1) (as shown in FIG. 9 and FIG. 14 Block 1401). Typically, the mechanical interface (42) between the movement mechanism or robot (5) and the end effector (1) comprises two mating parts designed to couple together and pass utilities such as one or more of: controller output and input signals, electrical utilities, pneumatic utilities, liquids, or the like. In particular embodiments the mechanical interface (42) can be locked to behave as rigid mechanical interface (42) during motion of the robot (5) and can be a compliant mechanical interface (42) having sufficient degrees of freedom during constrained motion of the end effector (1) to perform a task. The method can further include moving the end effector (1) proximate a pack (7) or a stack of packs (7′″) (as shown in FIG. 9 and FIG. 14 Block 1402). The method can further include operating the end effector (1) (as shown in FIGS. 9 through 14 Block 1403 including one or more of Blocks 1404 through 1408). The method can further include engaging the gripper (14) with a pack side (11) (as shown in FIG. 9 and FIG. 14 Block 1404). Engaging a gripper (14) with a pack side (11), wherein engaging can comprise one or more of engaging a gripping surface (18) with the pack side (11) or can comprise engaging one or more gripper cups (20) to a pack side (11), or can comprise engaging one or more gripper cups (20) to a pack side (11) with or without generating a partial vacuum in the one or more gripper cups (20). Thus, the engagement of the gripper (14) with the pack side (11) can be solely frictional engagement without vacuum or can be engagement of the gripper (14) with vacuum to enhance frictional engagement, or combinations thereof. The method can further include moving the gripper (14) upward along the mast (13) (as shown in FIG. 10 and FIG. 14 Block 1405). The movement of the gripper (14) upward along the mast (13) can reduce the load exerted between a first pack and a second pack (7′, 7″) in a stack of packs (7′″) (or a pack and another surface), or can lift a portion of a first pack (7′) in stack of packs (7′″) upward from a second pack (7″) in the stack of packs (7′″). In particular embodiments, a portion of the first pack (7′) in a stack of packs (7′″) can be lifted away from the second pack (7″) in the stack of packs (7′″) (or away from another surface). The method can further include extending a support plate (15) in relation to the mast (13) to a position between the first pack (7′) in the stack of packs (7′″) and the second pack (7″) in the stack of packs (7′″) (or other surface) (as shown in FIG. 11 and FIG. 24 Block 1406). The support plate (15) can be positioned to support the pack bottom (10). The method can further include lowering the compressor arm (16) to engage the pack top (11) of the pack (7) (as shown in FIG. 12 and FIG. 14 Block 1407). Engaging the pack top (10) of the pack (7) can comprise one or more of engaging a compressor second end (30) of the compressor arm (16) to the pack top (10) or engaging a compression pad (32) of the compressor arm (16) to the pack top (10) or engaging vacuum compression pad (32) to the pack top (10). The compression pad (32) may compress to conform in whole or in part to the surface of the pack top (10). The method can further include moving the movement mechanism or robot (5) to correspondingly move the end effector (1) to move the pack (7) from a first location (3) to a second location (4) (as shown in FIG. 13 and FIG. 14 Block 1408).

As can be easily understood from the foregoing, the basic concepts of the present invention may be embodied in a variety of ways. The invention involves numerous and varied embodiments of an end effector (1) and methods for making and using such end effector (1) including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “gripper” should be understood to encompass disclosure of the act of “gripping”—whether explicitly discussed or not—and, conversely, were there is a disclosure of the act of “gripping”, such a disclosure should be understood to encompass disclosure of a “gripper” and even a “means for gripping”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the end effectors herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An end effector, comprising:
an upright mast;
a gripper movably coupled to said mast,
said gripper configured to engage a pack side of a pack;
a support plate extendable in relation to said upright mast,
said support plate configured to engage a pack bottom of said pack; and
a compressor arm movably coupled to said mast,
said compressor arm configured to engage a pack top of said pack,
said end effector having said support plate engaged to said pack bottom and said compressor arm engaged to said pack top adapted to move said pack from a first location to a second location.

2. The end effector of claim 1, wherein said gripper includes one or more cups configured to grip said pack side.

3. The end effector of claim 2, wherein said one or more cups have an internal surface which defines an interior space fluidically coupled to a vacuum source adapted to draw a partial vacuum in said interior space of said one or more cups.

4. The end effector of claim 3, wherein said gripper engaged to said pack side moves upward on said mast to lift a portion of said pack bottom.

5. The end effector of claim 1, wherein said compressor arm further includes a compression pad adapted to compress upon engaging said pack top.

6. The end effector of claim 5, wherein said compression pad defines a compression pad external surface fluidically coupled to a vacuum source adapted to draw a partial vacuum at said compression pad external surface.

7. The end effector of claim 1, wherein said first location comprises a first pallet containing a plurality of packs, and wherein said second location comprises a second pallet configured to receive one or more of said plurality of packs.

8. The end effector of claim 1, wherein said pack comprises a case or a carrier tray.

9. The end effector of claim 8, wherein said carrier tray comprises a cardboard carrier tray having a carrier tray bottom and interconnected upwardly extending carrier tray sides.

10. A method of making an end effector, comprising:
providing an upright mast;
movably coupling a gripper to said mast,
said gripper configured to engage a pack side;
coupling a support plate in extendable retractable relation to said mast,
said support plate configured to engage a pack bottom; and
moveably coupling a compressor arm to said mast,
said compressor arm configured to engage a pack top,
said end effector having said support plate engaged to said package bottom and said compressor arm engaged to said package top capable of moving a pack from a first location to a second location.

11. The method of claim 10, further comprising coupling one or more cups to said gripper, said one or more cups configured to grip said pack side.

12. The method of claim 11, further comprising fluidically coupling a vacuum source to an interior space of said one or more cups, said vacuum source adapted to draw a partial vacuum in said interior space of said one or more cups.

13. The method of claim 12, further comprising configuring said gripper to move upward on said mast with said gripper engaged to said pack side to lift a portion of said pack bottom.

14. The method of claim 10, further comprising coupling a compression pad to said compressor arm, said compression pad adapted to compress upon engaging said pack top.

15. The method of claim 14, further comprising fluidically coupling said compression pad to a vacuum source adapted to draw a partial vacuum at an external surface of said compression pad.

16. The method of claim 10, wherein said first location comprises a first pallet containing a plurality of packs, and wherein said second location comprises a second pallet configured to receive one or more of said plurality of packs.

17. The method of claim 16, wherein said pack comprises a case or a carrier tray.

18. The method of claim 17, wherein said carrier tray comprises a cardboard carrier tray having a carrier tray bottom and interconnected upwardly extending carrier tray sides.

19-27. (canceled)
